(19) United States
(12) Patent Application Publication
(10) Pub. No.: US 2005/0058382 A1
(43) Pub. Date: Mar. 17, 2005

(54) Steering hub bearing assembly

(76) Inventor: Steven S. Williams, Naperville, IL (US)

Correspondence Address: QUARLES & BRADY LLP, 411 E. WISCONSIN AVENUE, SUITE 2040, MILWAUKEE, WI, 53202-4497, US

(21) Appl. No.: 10/662,770

(22) Filed: Sep. 15, 2003

(51) Int. Cl. F16C 33/34

(52) U.S. Cl. 384/568

(57) ABSTRACT

A bearing assembly suitable for use in a motorcycle steering assembly includes an inner ring member having a convex inner race surface with opposing axial edges. An outer ring member encircles the inner ring member and defines a raceway space therebetween. The outer ring member includes at least two axially spaced outer race surfaces defining a lubrication groove therebetween. Flanges axially outwardly spaced from each outer race surface extend radially inwardly past the outer race surfaces to capture a roller therebetween. A plurality of rollers are disposed in the raceway space between the flanges. Each of the rollers include a concave radial race surface interposed between axially spaced radial race surfaces. Each of the axially spaced radial race surfaces engage one of the axially spaced outer race surfaces of the outer ring member and the concave radial race surface engages the inner ring member convex inner surface. In one embodiment, a seal spaced axially outwardly from each axial end of the rollers and disposed between the inner and outer ring members seal the rollers between said inner and outer ring members, and a collar is fixed to each axial end of the inner ring member to unitize the bearing assembly.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The field of invention is roller bearings, and more particularly, to a roller bearing assembly suitable for use in a motorcycle steering assembly.

A motorcycle steering assembly includes a steering stem extending through a tube, or steering hub, fixed to the motorcycle frame. The steering stem is fixed to forks, at one end, that rotatably mount the motorcycle front wheel and to handlebars, at the other end, for manipulation by the motorcycle rider. The steering hub is fixed to the motorcycle frame at an angle, such that the front wheel of the motorcycle is forward of the motorcycle frame. The angle of the steering hub to the vertical is referred to as the rake.

Bearings in the steering hub allow the steering stem to rotate as the motorcycle rider manipulates the handlebars to steer the motorcycle. Due to the typical operation of a motorcycle, rotation of the steering stem, however, is typically limited to small oscillating angles of motion. Moreover, due to the rake, large, transient, combined radial and axial loads are transferred to the bearings in the steering hub from the steering stem as the motorcycle front wheel encounters obstructions, pot holes, and the like, on a road. These loads can cause false brinelling (fretting) which damages the bearings and shorten the bearings useful life.

A typical motorcycle is designed with tapered roller bearings in the steering hub. Tapered bearings do not allow for misalignment induced by loads coming through the steering hub. As a result, the tapered bearings experience an edge load that creates high roller and race stresses that significantly shorten the bearing life. In addition, tapered roller bearings in the motorcycle steering hub typically incorporate a retainer to separate the rollers and prevent the rollers from skewing. Unfortunately, the retainer takes up space in the bearing raceway and reduces the number of rollers that are available for handling the bearing load stresses.

The retainer in combination with space constraints in the steering hub allows relatively little space in the bearing assembly for bearing lubricant. In addition, bearings typically used in the steering hub do not have seals, making the bearing prone to contamination from the environment in which the motorcycle operates and the loss of the small amount of lubricant in the bearing assembly. The loss and/or contamination of the relatively small amount of lubricant within the bearing can contribute significantly to a shortened useful bearing life.

The bearing typically used in the motorcycle steering hub are also difficult to assemble with the proper clearances and are prone to damage during installation. In particular, the current bearings have separable inner and outer rings that require time consuming clearance adjustment during motorcycle assembly. Moreover, the current bearings have a small inner ring face clamping area, and can experience galling from a shaft shoulder. Accordingly, a need exists for an improved bearing suitable for use in a motorcycle steering hub.

### BRIEF SUMMARY OF THE INVENTION

The present invention provides a bearing assembly that solves the problems of a short bearing life and high end-user installation costs. In particular, the bearing assembly disclosed herein is unitized (i.e. the inner and outer ring members are not separable), can include a full complement of rollers for a high load capacity, includes race surfaces that accept radial and axial loading, is sealed to prevent contamination and loss of lubricant, is self-aligning to prevent high bearing stresses, includes a large lubricant reservoir, does not require bearing clearance/preload adjustment, and has a large clamping area to minimize clamping damage. Although the bearing disclosed herein is especially suitable for use in a motorcycle steering assembly, it can be used in any applications requiring bearings without departing from the scope of the invention.

In one embodiment of the present invention, a bearing assembly includes an inner ring member including a convex inner race surface having opposing axial edges. An outer ring member encircles the inner ring member and defines a raceway space therebetween. The outer ring member includes at least two axially spaced outer race surfaces defining a lubrication groove therebetween. Flanges axially outwardly spaced from each outer race surface extend radially inwardly past the outer race surfaces to capture a roller therebetween. A plurality of rollers are disposed in the raceway space between the flanges. Each of the rollers include a concave radial race surface interposed between axially spaced radial race surfaces. Each of the axially spaced radial race surfaces engage one of the axially spaced outer race surfaces of the outer ring member and the concave radial race surface engages the inner ring member convex inner surface. In one embodiment, a seal spaced axially outwardly from each axial end of the rollers and disposed between the inner and outer ring members seal the rollers between said inner and outer ring members, and a collar is fixed to each axial end of the inner ring member to unitize the bearing assembly.

The foregoing and other advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is an axial elevational view of a steering hub bearing assembly incorporating the present invention with the seals removed;

FIG. 2 is a cut away radial view of the bearing assembly of FIG. 1;

FIG. 3 is an exploded radial view of the bearing assembly of FIG. 1; and

FIG. 4 is a detailed sectional view along line 4-4 of FIG. 2.

### DETAILED DESCRIPTION OF THE PREFERRED EMBODIMENTS

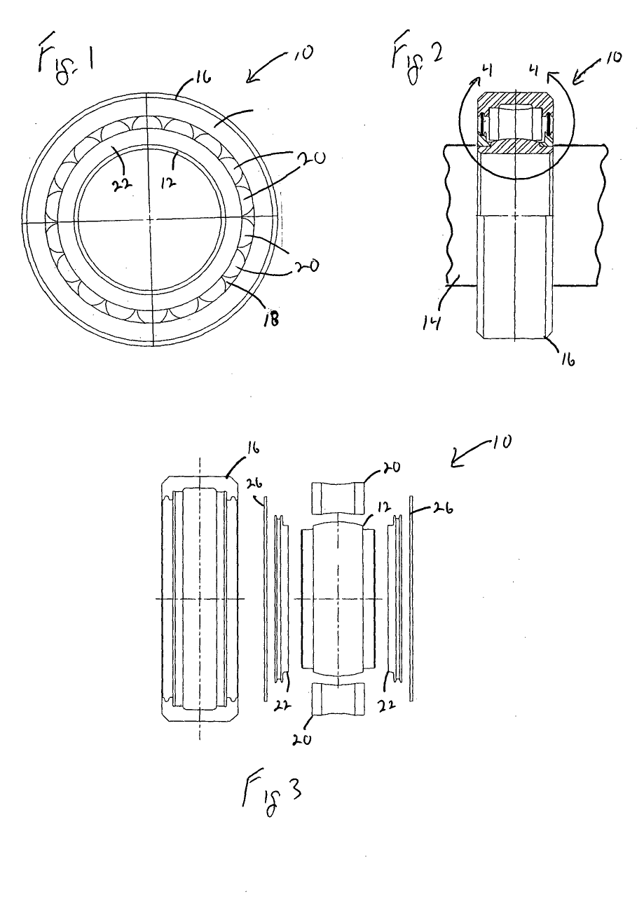

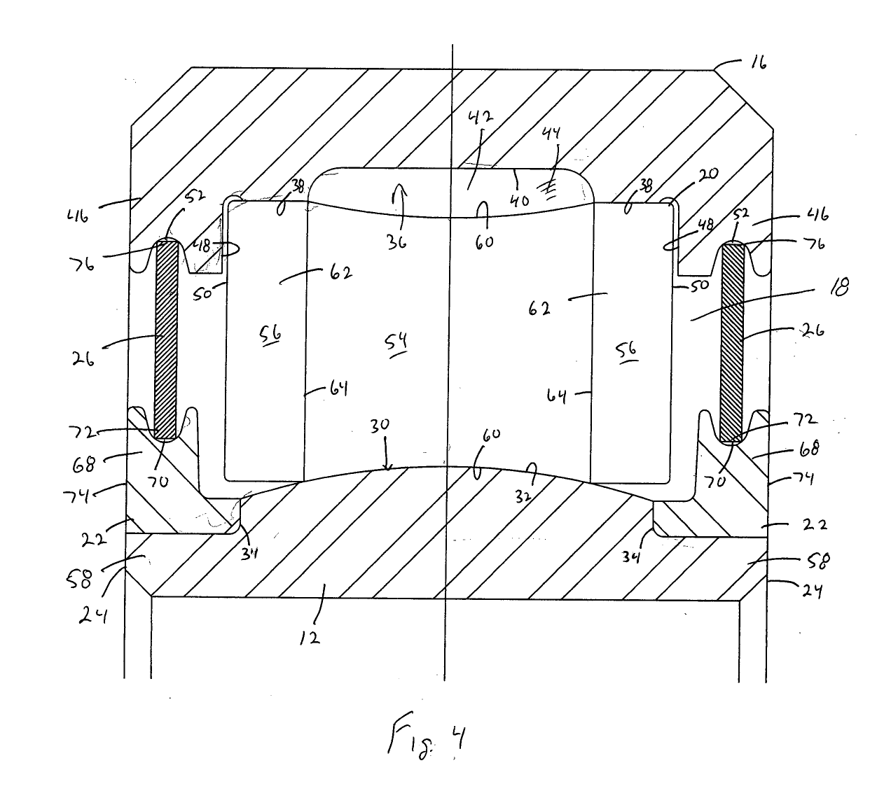

As shown in FIGS. 1-4, a steering hub bearing assembly 10 suitable for use in a motorcycle steering hub includes an inner race, or ring member 12, through which a shaft, such as a motorcycle steering stem 14, extends. An annular outer race, or ring member 16, encircles the inner ring member 12 and defines a single row raceway space 18 between the inner and outer ring members 12, 16. A plurality of rollers 20 disposed in the raceway space 18 allow rotational movement of the inner and outer ring members 12, 16 relative to each other. Circumferentially grooved collars 22 are secured on opposite axial ends 24 of the inner ring member 12 for unitizing the bearing assembly 10 and engaging a seal 26 to seal the bearing assembly 10 from contaminants

The annular inner ring member 12 through which the steering stem 14 extends includes a convex, spherical outer surface 30 forming an inner bearing race surface 32 for engagement with the rollers 20. Advantageously, the convex shape of the inner bearing race surface 32 transfers radial and axial loads by engaging a concave race surface 60 of the rollers 20 while maintaining the ability to self-align relative to the rollers 20 and outer ring member 16. Although a spherical convex inner bearing race surface 32 is preferred, the inner bearing race surface 32 can have any convex shape without departing from the scope of the invention.

Hub extensions 58 extending axially from each axial edge 34 of the inner bearing race surface 32 engage the collars 22, as described below, to unitize the bearing assembly 10. Although hub extensions 58 are preferred, other structure for engaging collars, such as axially opening grooves for receiving tongues extending from collars, can be provided without departing from the scope of the invention.

The annular outer ring member 16 encircles the inner ring member 12 and defines the raceway space 18 between the inner and outer ring members 12, 16. An inner surface 36 of the outer ring member 16 includes a pair of spaced outer radial cylindrical race surfaces 38 for engagement with radial surfaces 62 of the rollers 20. Although a pair of cylindrical outer race surfaces 38 is preferred, any number of outer race surfaces can be provided without departing from the scope of the invention.

The pair of spaced outer race surfaces 38 define edges of a radially inwardly opening groove 40 therebetween. The groove 40 forms a lubrication reservoir 42 that holds lubricant 44 for lubricating the rollers 20. Preferably, the groove 40 only opens radially inwardly, and does not require refilling once the bearing assembly 10 is sealed by the seals 26. However, an orifice (not shown) formed through outer ring member 16 and including a fitting, such as a zerk fitting, can be provided to fill and/or refill the lubrication reservoir once the bearing assembly is sealed without departing from the scope of the invention.

A flange 46 disposed axially outwardly from each outer race surface 38 extends radially inwardly past the adjacent outer race surface 38. Preferably, each flange 46 is formed as an integral part of the outer ring member 16. However, the flange 46 can be formed as a separate piece, such as a collar fixed to the outer ring member, without departing from the scope of the invention.

Each flange 46 includes an axially inwardly facing axial race surface 48 for engaging ends 50 of the rollers 20 and capturing the rollers 20 therebetween. Although separate axial and outer race surfaces 48, 38 are preferred, the axial and outer race surfaces 48, 38 can be combined to provide an angled outer race surface facing into the raceway space 18 that engages a complementary radial race surface formed on the roller 20 for transferring radial and axial loads. Radially inwardly opening grooves 52 formed in each flange 46 engage an outer radial edge 76 of one of the bearing seals 26.

The plurality of rollers 20 are disposed in a single row between the flanges 46 in the raceway space 18 between the inner and outer ring members 12, 16. Each roller 20 includes first and second radial race surfaces 54, 56. The first radial race surface 54 is the concave, spherical race surface 60 engaging the convex inner bearing race surface 32 of the inner ring member 12. Although a concave spherical race surface is preferred, the first radial race surface 54 can have any concave shape compatible with the inner bearing race surface 32 of the inner ring member 12 without departing from the scope of the invention.

The second radial race surface 56 includes a cylindrical race surface 62 formed adjacent each axial edge 64 of the first radial race surface 54. Each cylindrical race surface 62 engages one of the spaced outer race surfaces 38 of the outer ring member 16. Advantageously, the cylindrical race surfaces 62 also contact adjacent rollers 20 to control roller skew. As a result, a retainer is not required and a full complement of rollers can be installed to maximize bearing load capacity.

The collars 22 are press fit onto the hub extensions 58 to unitize the bearing assembly 10 and simplify installation of the bearing assembly 10 into the motorcycle steering hub. Although press fitting each collar 22 onto the hub extensions 58 of the inner ring member 12 is preferred, the collars 22 can be fixed to the inner ring member 12 using other methods such as threadably engaging the collars with the inner ring member, welding, and the like, without departing from the scope of the invention. Preferably, the collars 22 are dimensioned to form a positive, internal misalignment stop to prevent bearing misalignment beyond an acceptable limit.

Each collar 22 includes a radially outwardly extending collar flange 68 having an axially outwardly facing surface 74. Preferably, the collar flange 68 extends radially outwardly to minimize the seal material and provide a large outwardly facing surface 74 for clamping the bearing in place in the steering hub. Advantageously, proper size selection of the rollers and inner and outer ring members combined with the unitizing collars provides a bearing with the final desired internal bearing clearance or preload and eliminates the need to adjust the bearing assembly 10 upon installation into the steering hub. A circumferential groove 70 formed in each collar flange 68 engages an inner radial edge 72 of the bearing seal 26.

Each annular seal 26 is interposed between the outer ring member 16 and one of the collars 22. The outer radial edge 76 of the seal 26 is received in the groove 52 formed in the outer ring member flange 46 and the inner radial edge 72 of the seal 26 is received in the circumferential groove 70 formed in the collar 22. The grooves 52, 70 retain the seal 26 which protects the bearing assembly 10 from contamination and prevents the loss of lubricant 44.

The bearing assembly 10 can be assembled by slipping the rollers 20 into the outer ring member 16 between the outer ring member flanges 46. The inner ring member 12 is then slipped into the center of the outer ring member 16 between the rollers 20 to capture the rollers 20 in the raceway space 18 between the inner and outer ring members 12, 16. The collars 22 are then press fit onto the hub extensions 58 to unitize the bearing assembly 10. Lubricant 44 is then injected into the raceway space 18 filling the lubrication reservoir 42. The seals are hen flexed to force the seal edges 72, 76 into the grooves 70, 52 to seal the lubricant 44 in the bearing assembly 10 and prevent contaminants from entering the raceway space 18. Of course, the bearing assembly can be assembled in any manner that results in the assembled bearing assembly without departing from the scope of the invention. For example, lubricant can be injected into the lubricant reservoir before slipping the roller into the outer ring member, and the like.

While there have been shown and described what is at present considered the preferred embodiments of the invention, it will be obvious to those skilled in the art that various changes and modifications can be made therein without departing from the scope of the invention defined by the appended claims.

1. A bearing assembly comprising:
an inner ring member including a convex inner race surface having opposing axial edges;
an outer ring member encircling said inner ring member and defining a raceway space therebetween, said outer ring member including at least two axially spaced outer race surfaces defining a lubrication groove therebetween;
a flange axially outwardly spaced from each outer race surface extends radially inwardly past said outer race surfaces;
a plurality of rollers disposed in said raceway space between said flanges, each of said rollers including a concave radial race surface interposed between axially spaced radial race surfaces, each of said axially spaced radial race surfaces engaging one of said axially spaced outer race surfaces of said outer ring member and said concave radial race surface engaging said inner ring member convex inner surface;
a seal spaced axially outwardly from each axial end of said rollers and disposed between said inner and outer ring members to seal said rollers between said inner and outer ring members; and
a collar fixed to each axial end of said inner ring member to unitize said bearing assembly.

2. The bearing assembly as in claim 1, in which each of said flanges includes an axial race surface engageable with an end of said rollers.

3. The bearing assembly as in claim 1, in which a hub extension extends axially outwardly from each axial edge of said inner race surface, and each of said collars is fixed to one of said hub extensions.

4. The bearing assembly as in claim 3, in which each of said collars is press fit onto one of said hub extensions.

5. The bearing assembly as in claim 1 in which said lubrication reservoir is only open radially inwardly.

6. The bearing assembly as in claim 1, in which at least one of said flanges includes and radially inwardly opening groove and at least one of said collars includes a circumferential groove opening toward said radially inwardly opening groove of said at least one of said flanges, and said seal includes a outer radial edge engaging said radially inwardly opening groove of said at least one of said flanges and a inner radial edge engaging said circumferential groove.

7. The bearing assembly as in claim 1, in which a steering stem of a motorcycle steering assembly extends axially through said inner ring member.

8. The bearing assembly as in claim 1, in which each of said flanges is formed as an integral part of said outer ring member.

9. The bearing assembly as in claim 1, in which a lubricant is disposed in said lubrication reservoir.

10. The bearing assembly as in claim 1, in which said axially spaced radial race surfaces of said rollers are cylindrical.

11. The bearing assembly as in claim 1, in which said plurality of rollers are arranged in single row.

12. A bearing assembly comprising:
an inner ring member including a convex inner race surface having opposing axial edges;
an outer ring member encircling said inner ring member and defining a raceway space therebetween, said outer ring member including at least two axially spaced outer race surfaces defining a lubrication groove therebetween;
a flange axially outwardly spaced from each outer race surface extends radially inwardly past said outer race surface, each of said flanges including an axially inwardly facing race surface;
a plurality of rollers disposed in said raceway space between said flanges, each of said rollers including a concave radial race surface interposed between axially spaced radial race surfaces, each of said axially spaced radial race surfaces engaging one of said axially spaced outer race surfaces of said outer ring member and said concave radial race surface engaging said inner ring member convex inner surface;
a seal spaced axially outwardly from each axial end of said rollers and disposed between said inner and outer ring members to seal said rollers between said inner and outer ring members; and
a collar fixed to each axial end of said inner ring member to unitize said bearing assembly.

13. The bearing assembly as in claim 12, in which each of said flanges is formed as an integral part of said outer ring member.

14. The bearing assembly as in claim 12, in which a hub extension extends axially outwardly from each axial edge of said inner race surface, and each of said collars is fixed to one of said hub extensions.

15. The bearing assembly as in claim 14, in which each of said collars is press fit onto one of said hub extensions.

16. The bearing assembly as in claim 12 in which said lubrication reservoir is only open radially inwardly.

17. The bearing assembly as in claim 12, in which at least one of said flanges includes and radially inwardly opening groove and at least one of said collars includes a circumferential groove opening toward said radially inwardly opening groove of said at least one of said flanges, and said seal includes a outer radial edge engaging said radially inwardly opening groove of said at least one of said flanges and a inner radial edge engaging said circumferential groove.

18. The bearing assembly as in claim 12, in which a steering stem of a motorcycle steering assembly extends axially through said inner ring member.

19. The bearing assembly as in claim 12, in which a lubricant is disposed in said lubrication reservoir.

20. The bearing assembly as in claim 12, in which said axially spaced radial race surfaces of said rollers are cylindrical.

21. The bearing assembly as in claim 12, in which said plurality of rollers are arranged in single row.

22. A bearing assembly comprising:
an inner ring member including a convex inner race surface having opposing axial edges;
an outer ring member encircling said inner ring member and defining a raceway space therebetween, said outer ring member including at least two axially spaced outer race surfaces defining a lubrication groove therebetween;
a flange axially outwardly spaced from each outer race surface extends radially inwardly past said outer race surfaces to capture a roller; and
a plurality of rollers disposed in said raceway space between said flanges in a single row, each of said rollers including a concave radial race surface interposed between axially spaced radial race surfaces, each of said axially spaced radial race surfaces engaging one of said axially spaced outer race surfaces of said outer ring member and said concave radial race surface engaging said inner ring member convex inner surface.
